(19) United States
(12) Patent Application Publication
(10) Pub. No.: US 2025/0334961 A1
(43) Pub. Date: Oct. 30, 2025

(54) Control Unit for Generating a Synthetic Data for an Industrial Machine

(71) Applicants: Robert Bosch GmbH, Stuttgart (DE); Bosch Global Software Technologies Private Limited, Bangalore (IN)

(72) Inventors: Ahmad Saad, Bangalore (IN); Sanket Sanjay Thakre, Nagpur (IN)

(21) Appl. No.: 19/193,169

(22) Filed: Apr. 29, 2025

(30) Foreign Application Priority Data
Apr. 30, 2024 (IN) 2024 4103 4362

(51) Int. Cl. G05B 23/02

(52) U.S. Cl. CPC G05B 23/0224; G05B 23/0208

(57) ABSTRACT

A control unit receives data from multiple sensors connected to a reference machine and stores the data in a memory. The control unit further receives new data from at least one sensor connected to the industrial machine in an operating mode and compares the received new data with the stored data for generating the synthetic data related to the industrial machine based on the comparison and a scaling factor. With the help of the disclosed methodology, a deployable algorithm to generate fault data in industrial settings can be achieved. The control unit develops an intelligence learning model, like a machine learning model, and deploys to make predictions on the industrial machine in a short time based on a customer's asset data.

This application claims priority under 35 U.S.C. § 119 to application no. IN 2024 4103 4362, filed on Apr. 30, 2024 in India, the disclosure of which is incorporated herein by reference in its entirety.

The disclosure is related to a control unit for generating a synthetic data for an industrial machine and a method thereof.

### BACKGROUND

Few industrial machinery are equipped with sensors and the ones that are sensorized do not have an adequate amount of quality fault data to train a machine learning model. Failure data for any machine component is very low in volume compared to normal working data. Moreover, when the failure data is distributed among various faults in the machine, the volume shrinks even further. Hence, a model trained on such dataset will not be able to properly detect various faults. As an alternative, creating faults manually in an industrial machine is not feasible as it may halt the production process and incur economic losses. In the scenario where historical data is not available and the assets are digitalized only after a project is offered, waiting for a fault to happen, and then collecting data to train a machine learning model will be very time consuming.

A US patent application 20190339685 discloses a system generally includes a sensor detecting a condition of an industrial machine, the sensor producing a signal that varies over time and substantially corresponds with the condition; an analog to digital converter that receives the signal and samples the signal at a streaming sample rate that is at least twice a dominant frequency of the signal, the sampled signal being output from the analog to digital converter as a sequence of data values; and at least one digital signal router that receives the sequence of data value and a sub-sampling rate, wherein the sub-sampling rate is lower than the streaming sample rate, and produces at least one sub-sampled output sequence of data comprising select samples from the sequence of samples based on at least one of the sub-sampling rate and a ratio of the streaming sample rate and the sub-sampling rate.

### BRIEF DESCRIPTION OF THE DRAWINGS

FIG. 1 illustrates a control unit for generating a synthetic data for an industrial machine according to one embodiment of the disclosure; and

FIG. 2 illustrates a flowchart of a method of generating the synthetic data for the industrial machine according to the present disclosure.

### DETAILED DESCRIPTION

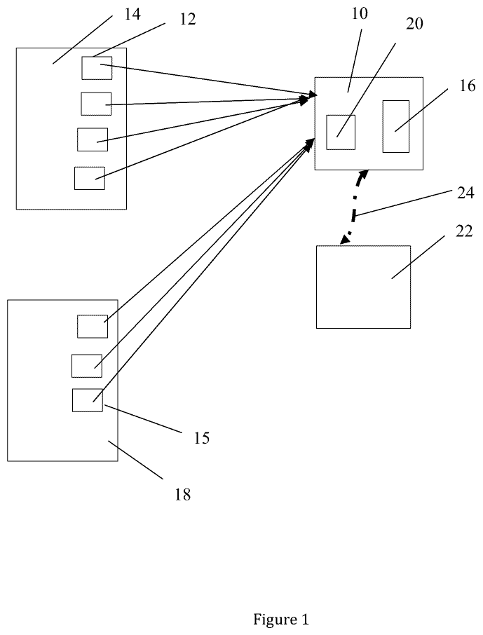

FIG. 1 illustrates a control unit for generating a synthetic data for an industrial machine according to one embodiment of the disclosure. The control unit 10 receives data from multiple sensors 12 connected to a reference machine 14 and stored the data in a memory 16. The control unit 10 further receives new data from at least one sensor 15 connected to the industrial machine 18 in an operating mode and compares the received new data with the stored data for generating the synthetic data related to the industrial machine 18 based on the comparison and a scaling factor.

Further construction of the control unit and the working of the control unit when connected to the industrial machine is explained in detail. The control unit 10 is chosen from a group of control units comprising a microcontroller, a microprocessor, a digital circuit, an integrated chip, an ASCII circuit and the like. The control unit 10 performs at least one function related to the industrial machine 18/reference machine 14 during the operating condition of the machines (14 & 18). The machines (industrial machine 18/reference machine 14) are connected to the multiple sensors 12, wherein the sensors 12 are used to detect various parameters of the machine 14/18 during the operating condition of the machines 14/18. The data generated during these operating conditions comprises both the healthy data and the faulty data, wherein the faulty data further comprises a loose data and a dent data. These data that is related to the reference machine 14 is stored in a memory 16 of the control unit 10 for future use. However, the generated data can also be stored in a cloud repository 22 and the control unit 10 access the data using the wireless communication device 24.

The control unit 10 further comprises a variation module 20, wherein, depending on at least one machine parameter, the scaling factor is varied. I.e., if the industrial machine 18 is more powerful and bigger than the reference machine 14, then the scaling factor is increased accordingly. The scaling factor enhancement depends on various machine parameters like the power of the machine, size of the machine, speed of the machine and the like. The synthetic data of the industrial machine 18 is generated based on a scaling factor. The scaling factor is varied by a variation module of the control unit 10 based on the at least one machine parameter as disclosed above. The scaling factor is decreased/increased, when the at least one machine parameter is compared between the reference machine 14 and the industrial machine 18.

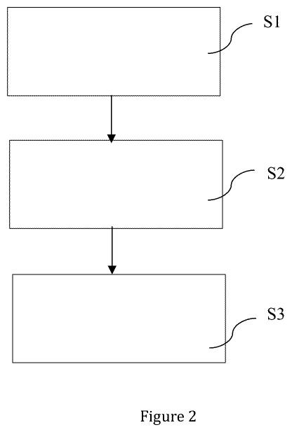

FIG. 2 illustrates a flowchart of a method of generating a synthetic data for an industrial machine 18 according to the present disclosure. In step S1, data from multiple sensors 12 connected to a reference machine 14 is received and stored the data in a memory 16 of a control unit 10. In step S2, new data from at least one sensor 15 connected to the industrial machine 18 in an operating mode is received. In step S3, the received new data is compared with the stored data for generating the synthetic data related to the industrial machine 18.

The method is explained in detail. Synthetic data generation is picking up pace and it is researched extensively to solve AI/ML problems. In predictive maintenance, synthetic data is another viable alternative as fault data in such cases are rare. Existing methods to generate synthetic machinery such as multi-body simulation, finite element analysis, and mathematical modeling have their cons, are sometimes computationally expensive and fail to completely mimic real-world scenarios. According to one embodiment of the disclosure, the reference machine 14 is a centrifugal blower. However, it can be any other reference machine 14 that resembles the industrial machine 18. For example, a radial blade test bench centrifugal blower that resembles a bigger radial blade industrial centrifugal blower is considered.

Creating a fault in a test bench machine is simple and some are equipped with faulty parts for experiments already. Then the relationship between healthy and faulty data is generated and used, using various digital signal processing techniques. The above disclosed technique is applied on the healthy data from the industrial machine 18. These techniques differentiate between healthy and faulty signals, and few are reversible i.e., one can get back the original signal from the transformed signal. Therefore, the control unit 10 identifies a relationship between healthy and faulty signals and then apply the same to the healthy industrial data to synthesize fault data.

The reference machine 14 is employed/operated in multiple environments and under multiple working conditions. Plurality of sensors 12 are connected to the reference machine 14 for generating the data related to the reference machine 14 during the various operating modes. The data includes healthy data and the faulty data. The healthy data is generated during the normal working conditions of the reference machine 14, wherein the faulty data is generated during any one the fault occurrence either in any one of the sensor 12 or in the machine 14 (due to the loose connections or not working of any component of the machine 14). It is to be understood, that the faults can be any other type and is not limited to above disclosed faults.

These data are stored in a control unit 10 connected to the reference machine 14 through a wired or wireless connection. The wireless connection uses any one of the communication device 24 comprising a WI-FI signal, a Bluetooth signal, an infrared signal, a zigbee and the like. The generated data can be stored either in a memory 16 of the control unit 10 or in a cloud repository 22 that can be accessed by the control unit 10 via the communication device 24.

In the real-time environment, the industrial machine 18 which is on the testing bed or in calibration process, is connected with multiple sensors 12 for understanding the working conditions of the machine. The machine 18 is operated in those working conditions and the data (vibrational data) is generated from the multiple sensors that are connected to the industrial machine 18. Thus the new data that is related to the industrial machine 18 is compared with the stored data, for better understanding of the possible faults and the different working conditions of the industrial machine 18.

In this process of comparison of the stored data and the new data, the control unit considers the scaling factor during the comparison. The control unit 10 either scales up or down the scaling factor based on the industrial machine 18 and then compares the new data with the stored data. This provides the information on the possible faults and the other working conditions of the industrial machine 18 well in advance. The above-disclosed method, provides a less time-consuming and expensive solution. The above method generates the synthetic fault data from healthy data by reversing the signal processing techniques that differentiate healthy from faulty data.

The signals captured from the industrial machine 18 which include vibration, current, voltage, and, acoustics, are then processed using digital signal processing techniques such as Fast Fourier Transform (FFT), filtering or Wavelet Transform. The control unit 10 establishes a relationship between faulty and healthy transformed signals and apply it on the healthy industrial machine signals to get transformed faulty signals. Afterwards, the faulty signals are inverted back to get raw faulty signals. The faulty data thus generated along with the collected healthy data is used to train the industrial machine learning model to detect faults in the industrial machine 18. The method is first validated on the test bench by passing the actual fault data to a model trained on synthetic data.

The above method is explained with an example. Only few industries have digitalized their assets, which leads to scarcity of relevant historical data for failures of industrial machines. Collecting failure data from industrial machines is time-consuming and infeasible. If one has an identical machine (reference machine 14) on a test bench, then it is possible to synthesize fault data for an industrial machine 18. This process consumes less time and does not require high-end hardware. The present disclosure discloses one such methodology. A fault in the industrial machine 18 is majorly detected by vibration signals, electrical signals, acoustic signals, and other process parameters. In most cases, just by visualizing the raw signal in the time domain, it is hard to differentiate between a healthy signal and a faulty signal due to the noise present in the signal or the fault not being severe enough to influence the raw signal. Therefore, various signal processing techniques such as filtering, Fast Fourier Transform (FFT), wavelet transform, and Empirical Mode Decomposition (EMD) are used.

With the help of these techniques, the signals can be differentiated between healthy and faulty. In most cases, these techniques are reversible, the control unit 10 reconstruct the processed signal back into the original signal. A time domain signal is just a one-dimensional array containing the values with respect to time. Similarly, FFT transforms a raw time-domain signal into a frequency-domain signal, which contains the dominance of frequencies present in the signal. Each machine 18 has some characteristic frequency associated with it, one of them is a rotating frequency.

The amplitudes of the characteristic frequencies determine the state of the machine 18. Usually, high amplitudes at those frequencies imply faulty signals. Once the control unit 10 have the frequency-domain signal for various states of the machine 18, the control unit 10 makes the ratios of the fault signal with the healthy signal around the various characteristic frequencies and its harmonics. Then the control unit 10 transforms the time-domain healthy signal from a bigger industrial machine and scale the amplitudes of the characteristic frequencies. The healthy frequency-domain signal will then be converted into a faulty frequency-domain signal. Finally, it can be inverted back into time-domain to get a faulty time-domain signal. The same step can be repeated for all the faulty data.

Similarly for wavelet analysis, the signal is decomposed into various smaller signals which are different in the case of healthy and faulty conditions. The control unit 10 establishes a relationship or ratios between faulty and healthy wavelet analysis. Then the control unit 10 scales the healthy signal from another similar machine (reference machine 14) and reconstruct the time domain signal. Thus, the control unit 10 receives or acquires a proper dataset containing various faulty signals in appropriate volume and variety, this dataset can then be used to train any kind of machine learning model which will be used to make predictions on the live signals coming from the machine 18 and alert the user in case of a fault. The technique is validated by using the model trained on the synthetic data and using it to predict the actual fault data from the test bench.

With the help of the disclosed methodology a novel, deployable algorithm to generate fault data in industrial settings can be achieved. The control unit 10 develops a intelligence learning model (for example, a machine learning model) and deploys to make predictions on the industrial machine 18 in a short time based on a customer's asset data.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A control unit for generating a synthetic data for an industrial machine, said control unit configured to:
receive data from multiple sensors connected to a reference machine and store the data in a memory;
receive new data from at least one sensor connected to the industrial machine in an operating mode; and
compare the received new data with the stored data for generating the synthetic data related to the industrial machine.

2. The control unit as claimed in claim 1, wherein the synthetic data of the industrial machine is generated based on a scaling factor.

3. The control unit as claimed in claim 2, wherein the scaling factor is varied by a variation module of the control unit based on at least one machine parameter chosen from a group of parameters that includes a speed of the machine, a size of the machine, and a power of the machine.

4. The control unit as claimed in claim 2, wherein the scaling factor is decreased and/or increased when the at least one machine parameter is compared between the reference machine and the industrial machine.

5. The control unit as claimed in claim 1, wherein the stored data comprises healthy data and the faulty data of the reference machine that is received and stored during multiple operating conditions of the reference machine.

6. The control unit as claimed in claim 1, wherein the synthetic data of the industrial machine comprises the fault data and the normal working condition data, when compared with the stored data of the reference machine and from the scaling factor.

7. The control unit as claimed in claim 1, wherein the reference machine is a centrifugal blower and the data related to the reference machine and/or industrial machine is a vibrational data.

8. The control unit as claimed in claim 1, wherein the data is stored in a cloud repository and the control unit accesses the stored data via a communication device.

9. A method of generating a synthetic data for an industrial machine, comprising:
receiving data from multiple sensors connected to a reference machine and storing the data in a memory of a control unit;
receiving new data from at least one sensor connected to the industrial machine in an operating mode; and
comparing the received new data with the stored data by the control unit for generating the synthetic data related to the industrial machine.
